(19) United States
(12) Patent Application Publication
(10) Pub. No.: US 2010/0301720 A1
(43) Pub. Date: Dec. 2, 2010

(54) CABLE MANAGEMENT MODULE WITH PIVOT COVER ASSEMBLY

(76) Inventors: CHAD ANDERSON, NEW PRAGUE, MN (US); TIMOTHY HAATAJA, PRIOR LAKE, MN (US); CINDY S. WALTERS, PRIOR LAKE, MN (US)

Correspondence Address: MERCHANT & GOULD PC, P.O. BOX 2903, MINNEAPOLIS, MN, 55402-0903, US

(21) Appl. No.: 12/765,046

(22) Filed: Apr. 22, 2010

Related U.S. Application Data
(60) Provisional application No. 61/177,427, filed on May 12, 2009.

(51) Int. Cl. A47B 81/00; E05F 5/06; A47B 95/00

(52) U.S. Cl. 312/319.2; 312/326; 16/82

(57) ABSTRACT

The present disclosure provides a cable management module having a cover assembly that is secured in the closed position and when manually opened stays in the open position until manually closed. A method of accessing a cable management module is also provided.

### CROSS-REFERENCE TO RELATED APPLICATIONS

This application claims the benefit of U.S. Provisional Application Ser. No. 61/177,427, filed May 12, 2009; which application is incorporated herein by reference.

### TECHNICAL FIELD Fiber optical terminal cable management modules that provide the ability to terminate, splice and store fiber optical jumpers in fiber panels.

### BACKGROUND

Fiber optical terminal cable management modules provide the ability to terminate, splice and store fiber optical jumpers in fiber panels. Typically, the modules include a cover assembly that opens to allow access to the inside of the modules. In some configurations the cover assembly is configured so that once the cover is opened it stays opened until the user manually closes the cover. This feature is desirable as it allows the user of the modules to access it without manually holding open the cover. Modules with improved cover assemblies that stay open once opened are desirable.

### SUMMARY

The present disclosure provides a cable management module having a cover assembly that is secured in the closed position and when manually opened stays in the open position until manually closed. A method of accessing a cable management module is also provided.

### BRIEF DESCRIPTION OF THE DRAWINGS

FIG. 1 is a perspective view of a cable management module according to the present disclosure with a cover assembly in a closed position;

FIG. 2 is a perspective view of the cable management module of FIG. 1 with the cover assembly in an open position;

FIG. 3 is a top view of the cable management module of FIG. 1;

FIG. 4 is a front view of the cable management module of FIG. 1;

FIG. 5 is an end view of the cable management module of FIG. 1;

FIG. 6 is an enlarged view of a portion of FIG. 5;

FIG. 7 is a cross-sectional view of the cable management module of FIG. 1 along line 7-7 of FIG. 4;

FIG. 8 is an enlarged view of a portion of FIG. 7; and

FIG. 9 is a front view of the cable management module mounted to a rack with other modules mounted thereto.

### DETAILED DESCRIPTION

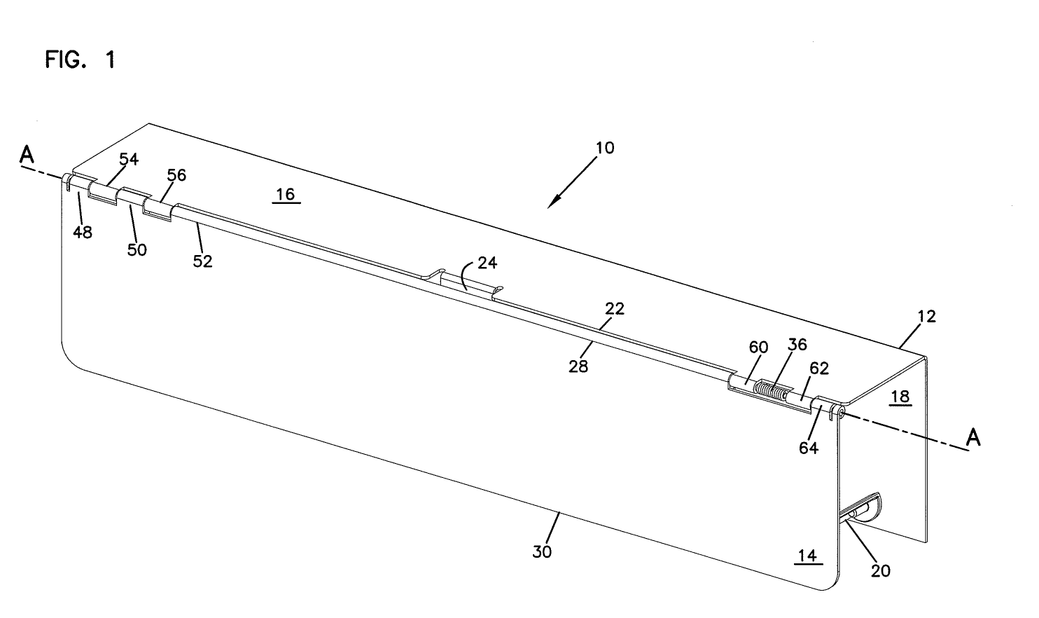

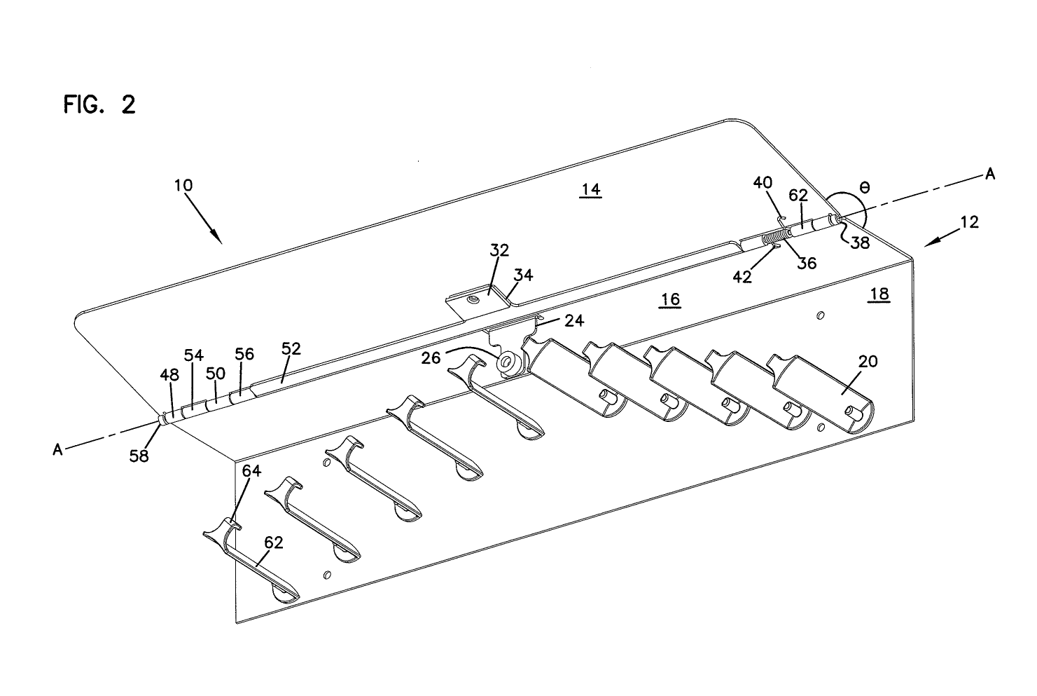

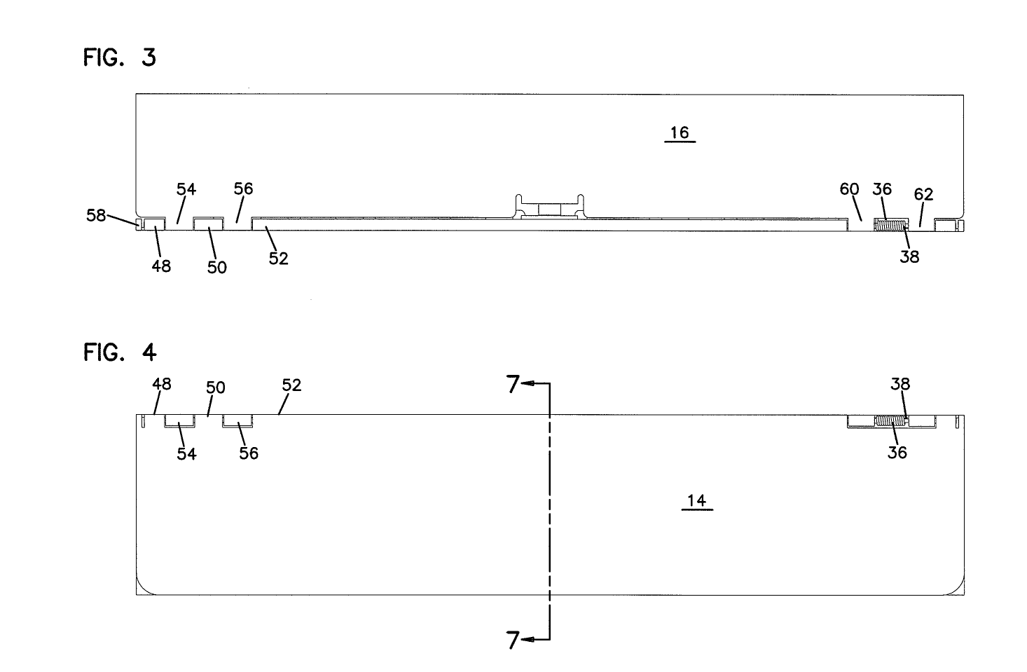

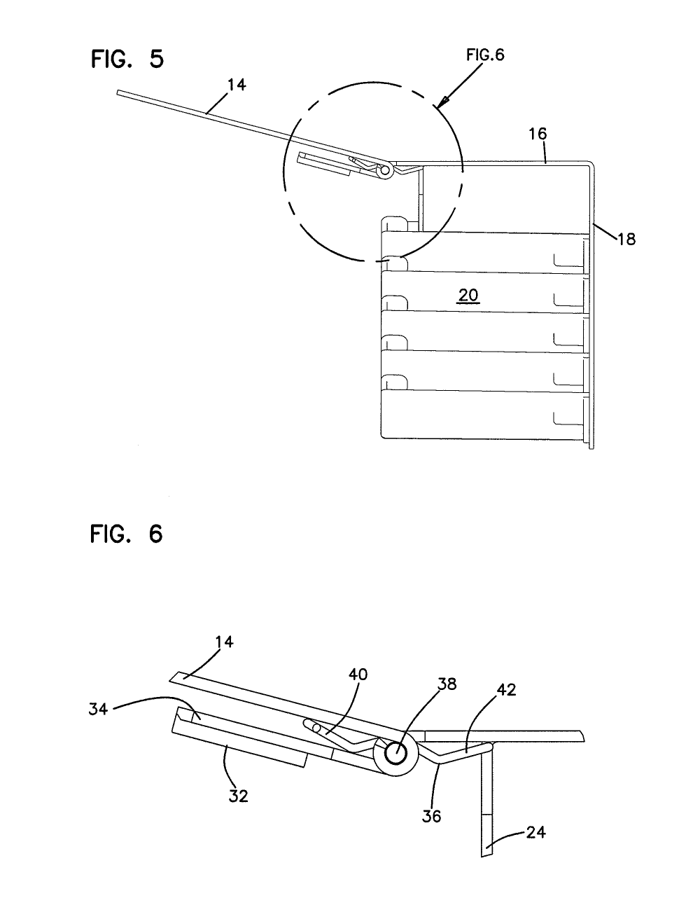

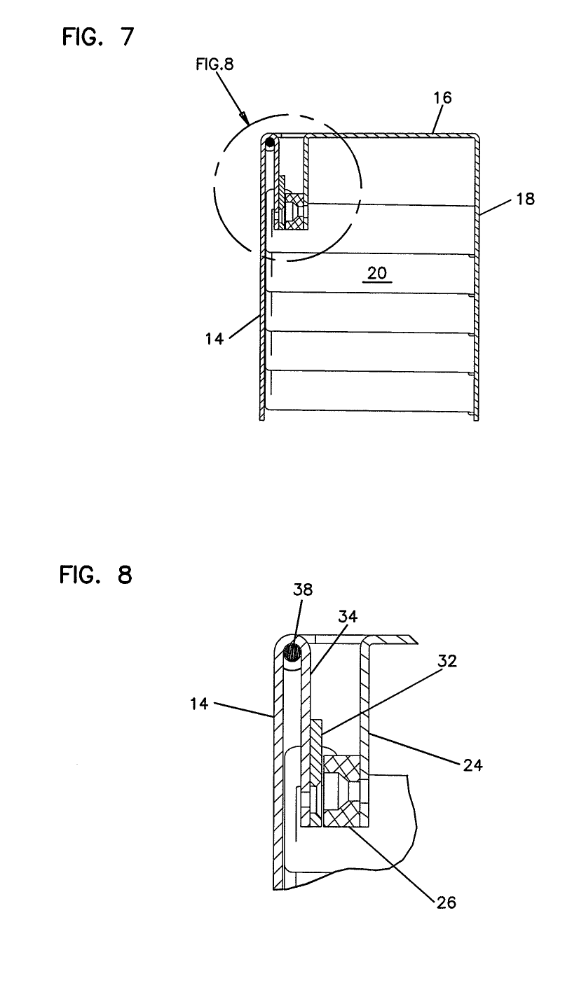

Referring to FIGS. 1-8, an embodiment to a cable management module with a cover assembly according to the present disclosure is shown. In the depicted embodiment, the cable management module 10 includes a frame 12 and a door 14 that pivots relative to the frame 12.

In the depicted embodiment, the frame 12 includes a top wall 16 that is shown in a horizontal orientation and a back wall 18 that is shown in a vertical orientation. Extending from the back wall 18 in a generally horizontal direction are a plurality of fanning members 20. The fanning members 20 are used to keep cables in the cable management module separated and spaced apart. In the depicted embodiment the front edge 22 of the top wall 16 of the frame 12 includes a tab 24 that extends downwardly. The tab 24 includes a magnet 26 thereon. The tab 24 is part of the retaining mechanism, which is described in greater detail below. It should be appreciated that many other alternative frame configurations are possible. For example, the frame of alternative embodiments of the cable management module can have a many different geometric configuration and they may or may not include fanning members therein.

In the depicted embodiment, the door 14 includes an upper edge 28 and a lower edge 30. The door 14 is pivotally mounted to the frame 12 about a horizontal axis A-A that is adjacent the upper edge 28 of the door 14. In the depicted embodiment door 14 extends generally horizontal when it is at 180° relative to the top wall 16, and the door extends generally vertically upward when it is at 90° relative to the top wall 16.

When the door 14 is in the closed position, it hangs from the hinged upper edge 28 in a generally vertical orientation (defining an angle θ that would be about 270°). When the door is in the open position, the door 14 and the top wall 16 of the frame are preferably at an angle θ, which is preferably between 0-225°. More preferably, the angle θ is between 90-180°, and even more preferably the angle θ is between 135-180°.

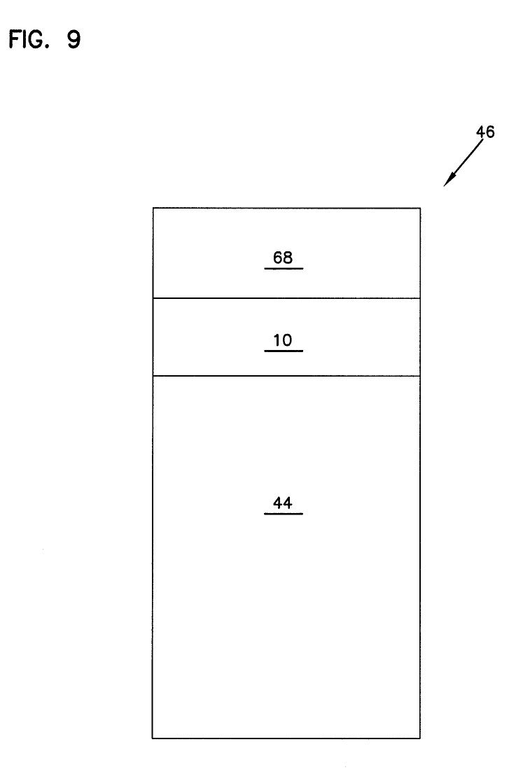

The above described preferred angles avoid inadvertent contact between the door 14 and other components (e.g., cables, connectors, etc.) that might be connected to modules 68 located above or modules 44 located below the cable management module 14 on a rack 46 (see FIG. 9). It should be appreciated that many other alternative door configurations are possible. For example, door of alternative embodiments of the cable management module can have many different geometric configurations than depicted and can be connected to the frame in different ways.

In the depicted embodiment, the door 14 is retained in its closed position in part due to gravity and in part due to a retaining mechanism, otherwise referred to as a first mechanism. The retaining mechanism includes the tab 24 with the magnet 26 and a contact pad 32 on a tab 34, which is located adjacent the inside surface of the door 14. In the depicted embodiment, the contact pad 32 includes a metallic construction and is arranged to engage the magnet 26. In the depicted embodiment, the retaining mechanism is located closer to the upper edge 28 of the door 14 than the lower edge 30 of the door 14. In the depicted embodiment, the tab 24 and the tab 34 are shown positioned between 0.5 to 5 inches from a pivot axis A-A of the door 14 and are generally positioned midway between the opposed ends of the door. In the depicted configuration, once the door 14 is manually closed it stays closed due to the magnetic attraction between the magnet 26 and the contact pad 32. It should be appreciated that many other alternative mechanisms for retaining the door in the closed position are possible.

In the depicted embodiment, an opening mechanism, otherwise referred to as a second mechanism, holds the door 14 open once it is manually pulled open by the user. In the depicted embodiment, the opening mechanism includes a spring 36 that is configured to biase the door 14 in the open direction. When the door 14 is in the closed position, the force of the spring 36 is not sufficient to overcome the attraction between the magnet 26 and the contact pad 32, therefore, the door stays closed. However, when the door 14 is manually pulled open by the user, the force of the spring is sufficient to keep the door 14 open even despite the force of gravity on the door 14.

In use the user grasps the lower edge 30 of the door 14 (e.g., at the either lower corner) and pulls outwardly and upwardly to release the first mechanism.

In the depicted embodiment, the spring 36 is a torsion type spring that includes a first portion 40 that presses against the door 14 and a second portion 42 that presses against the top wall 16 of the frame 12. The body of the spring 36 extends around the pivot rod 38, which is coincident with the pivot axis A-A.

In the depicted embodiment, the spring 36 is nested within the hinge arrangement. The hinge arrangement of the depicted embodiment is formed from the rolled tabs 48, 50, 64 located at the edge of the door that are nested with rolled tabs 54, 56, 60, 62 located at the edge of the top wall 16 of the frame 12. The rolled tabs 48, 50, 54, 56, 60, 62, 64 are configured such that the pivot rods 58, 38 on either end can extend through them. In the depicted embodiment, the edge of the door 14 between the hinge arrangements on either end of the module 14 is folded over forming a folded over lip 52. In the depicted embodiment, the spring 36 is located in a place what otherwise would be one of a rolled tab on the door 14 thereby nesting the spring 36 within the hinge arrangement. It should be appreciated that many other alternative mechanisms for keeping the door open once it is manually opened are possible.

In the depicted embodiment, the fanning member 20 includes a main body 62 with a curved shaped for cable bend radius protection. A cable retention finger 64 is provided on each fanning member 20. Other shape and arrangements for fanning members 20 are anticipated.

As shown, module 10 defines a cable management device with an open bottom and open sides. When door 14 is opened, the user has easy access to the interior for accessing the cable management structures within the interior.

The above specification, examples and data provide a complete description of the manufacture and use of the composition of the invention. Since many embodiments of the invention can be made without departing from the spirit and scope of the invention, the invention resides in the claims hereinafter appended.

We claim:

1. A cable management module comprising:
a frame;
a door including an upper edge and a lower edge, the door being pivotally mounted to the frame about a horizontal axis adjacent the upper edge of the door;
a first mechanism configured to hold the door in a closed position when the door is in the closed position;
a second mechanism configured to hold the door in an open position when the door is in the open position;
wherein when the door is in the closed position the first mechanism overcomes the force applied by the second mechanism to hold the door in the closed position.

2. The cable management module of claim 1, wherein the first mechanism includes a magnet.

3. The cable management module of claim 1, wherein the second mechanism includes a spring.

4. The cable management module of claim 3, wherein the spring is located adjacent the upper edge of the door and includes a first portion that contacts the door and a second portion that contacts the frame.

5. The cable management module of claim 4, wherein the upper edge of the door is pivotally connected to the frame via a hinge including a pivot rod and at least a portion of the spring is positioned around the pivot rod.

6. The cable management module of claim 5, wherein the spring is a torsion spring.

7. The cable management module of claim 2, wherein the first mechanism is located closer to the upper edge of the door than the lower edge of the door.

8. The cable management module of claim 6, wherein the first mechanism includes a first tab that extends from the frame and is configured to contact a second tab that extends from the door.

9. The cable management module of claim 8, wherein the first tab and the second tab are positioned between 0.5 to 3 inches from a pivot axis of the door.

10. The cable management module of claim 8, wherein the first tab includes a magnet mounted thereon and the second tab includes a metallic surface that is configured to contact the magnet.

11. The cable management module of claim 8, wherein the first tab and the second tab are positioned between 0.5 to 3 inches from a pivot axis of the door

12. The cable management module of claim 2, wherein the second mechanism includes a spring.

13. A cable management module comprising:
a frame including a top wall and a back wall;
a plurality of fanning members located in the frame extending from the back wall;
a door including an upper edge and a lower edge, the door being pivotally mounted to the top wall of the frame about the upper edge of the door;
a first mechanism configured to hold the door in a closed position when the door is in the closed position;
a second mechanism configured to hold the door in an open position when the door is in the open position.

14. The cable management module of claim 13, wherein at least one of the first or second mechanisms includes a magnet.

15. The cable management module of claim 14, wherein at least one of the first or second mechanism includes a spring.

16. The cable management module of claim 14, wherein when the door is in an open position the second mechanism holds the door an angle θ relative to the top wall, wherein the angle θ is between 135-180°.

17. A method of accessing a cable management module comprising:
providing a cable management module having a door that pivots about a horizontal axis that is adjacent an upper edge of the door, wherein the door is configured to be held closed with a magnet;
pulling the door open;
releasing the door allowing it to stay open due to the force of a spring.

18. The method of claim 17, wherein the spring is a torsion spring.

19. The method of claim 17, wherein the step of closing the door includes pressing down on the door against the force of the spring until the door is fully closed.

20. The method of claim 17, wherein the magnet is positioned equal distance from the first and second ends of the door.

21. The method of claim 20, wherein the magnet is positioned on the frame and does not pivot with the door.

22. The method of claim 17, wherein the cable management module includes a frame that defines an L-shape having a top wall and a back wall positioned 90° relative to one another.
